(19) United States
(12) Patent Application Publication
(10) Pub. No.: US 2022/0313054 A1
(43) Pub. Date: Oct. 6, 2022

(54) CONVEYOR DISHWASHER FOR CLEANING WASHWARE

(71) Applicant: ILLINOIS TOOL WORKS INC., Glenview, IL (US)

(72) Inventors: Harald DISCH, Elzach (DE); Martin SCHREMPP, Biberach (DE)

(21) Appl. No.: 17/626,963

(22) PCT Filed: Jul. 15, 2020
(86) PCT No.: PCT/US2020/042056

§ 371 Date: Jan. 13, 2022

(30) Foreign Application Priority Data
Jul. 18, 2019 (DE) 10 2019 119 462.8
Jan. 14, 2020 (DE) 10 2020 100 721.3

(51) Int. Cl. A47L 15/00; A47L 15/24

(52) U.S. Cl. CPC A47L 15/0071; A47L 15/247; A47L 15/245; A47L 2401/04

(57) ABSTRACT

A conveyor dishwasher for cleaning washware, in particular in the form of drinking vessels, wherein the conveyor dishwasher has at least one treatment zone and a housing, wherein the conveyor dishwasher also has a dirty-side feed -in region, by way of which washware which is to be cleaned in the at least one treatment zone is fed in manually, and a clean-side discharging region by way of which washware cleaned in the at least one treatment zone is discharged and removed manually, and a transporting apparatus for transporting washware from the feed-in region, through the at least one treatment zone, to the discharging region. The feed-in region and the discharging region are formed in one and the same side of the housing of the conveyor dishwasher or in directly adjacent sides of the housing.

### TECHNICAL FIELD

The present invention relates, in general, to the field of commercial dishwashing and, specifically, to a conveyor dishwasher according to the preamble of independent patent claim 1.

Accordingly, the invention relates, in particular, to a conveyor dishwasher for cleaning washware, in particular in the form of drinking vessels, such as coffee cups, wherein the conveyor dishwasher has at least one treatment zone and also a housing, in which the at least one treatment zone is accommodated. The conveyor dishwasher also has a dirty-side feed-in region, by way of which washware which is to be cleaned in the at least one treatment zone of the dishwasher is fed in manually, and a clean-side discharging region, by way of which washware cleaned in the at least one treatment zone of the dishwasher is discharged and removed manually. Furthermore, the conveyor dishwasher has a transporting apparatus for transporting washware from the feed-in region, through the at least one treatment zone of the conveyor dishwasher, to the discharging region.

### BACKGROUND

Conveyor dishwashers of this type are used in the commercial sector. In contrast to domestic dishwashers, in which the washware which is to be cleaned remains in a fixed location in the dishwasher during the cleaning operation, the washware in conveyor dishwashers is transported through various treatment zones of the machine.

A conveyor dishwasher of the type mentioned in the introduction is known, for example, from DE 19 644 438 A1. This conveyor dishwasher has, one after the other in the transporting direction of the washware, a pre-cleaning zone with pre-cleaning nozzles for removing heavy soiling on the washware, at least one wash zone with wash nozzles for spraying wash liquid onto the washware, a pre-rinse zone with pre-rinse nozzles, and a fresh-water final rinse zone with final rinse nozzles. The final rinse nozzles spray final rinse liquid, in particular fresh water, onto the washware. The final rinse liquid sprayed passes into a pre-rinse tank, from which it is delivered to the pre-rinse nozzles by means of a pump line. The pre-rinse liquid sprayed by the pre-rinse nozzles flows back into the pre-rinse tank. Some of the pre-rinse liquid sprayed by the pre-rinse nozzles is directed into the wash tank of the final wash zone by way of a deflecting plate. By way of a liquid-cascade system, liquid can flow, counter to the transporting direction of the washware, from the pre-rinse tank into the final wash tank and, from the latter, onward to a tank which collects the liquid sprayed by the pre-cleaning nozzles in the pre-cleaning zone.

Since conveyor dishwashers involve the washware being transported through various treatment zones (in particular wash zones and final rinse zones) of the machine, continuous operation is possible—in contrast to the batch processes of stationary box-type dishwashers, for example domestic dishwashers or under-counter machines. The disadvantage of conveyor dishwashers, however, is the relatively large amount of space required in the area where they are set up (utility room).

However, there is an increasing demand for utilizing the advantages of a conveyor dishwasher in applications in which there is only a small set-up area available.

### SUMMARY

Therefore, it is the object of the invention to develop a conveyor dishwasher of the type mentioned in the introduction so that it has a particularly compact construction, in order that the conveyor dishwasher can also be used for applications in which it has not been possible to use conventional conveyor dishwashers on account of a sufficient set-up area not being available.

This object is achieved according to the invention by a conveyor dishwasher as claimed in independent patent claim 1, advantageous developments of the conveyor dishwasher according to the invention being specified in the dependent claims.

Accordingly, the invention relates, in particular, to a conveyor dishwasher for cleaning washware, wherein the conveyor dishwasher has at least one treatment zone and also a housing, in which the at least one treatment zone is accommodated. The conveyor dishwasher also has a dirty-side feed-in region and also a clean-side discharging region. In the dirty-side feed-in region, the washware which is to be cleaned in the dishwasher, or in the at least one treatment zone of the dishwasher, is fed in preferably manually, whereas the clean-side discharging region is designed to discharge the washware cleaned in the dishwasher, and therefore the cleaned washware can be removed in particular manually from the clean-side discharging region.

The conveyor dishwasher also has a transporting apparatus in order to transport the washware from the feed-in region, through the at least one treatment zone of the conveyor dishwasher, to the discharging region.

In order to achieve as compact a construction of the conveyor dishwasher as possible, while reducing the set-up area which is necessary, provision is made according to the invention for the transporting path of the washware through the at least one treatment zone of the conveyor dishwasher to run not rectilinearly (as is the case in conveyor dishwashers known from the prior art), but along a two-dimensionally and in particular three-dimensionally curved route, and therefore the feed-in region and the discharging region of the conveyor dishwasher can ultimately be formed in one and the same side of the housing of the conveyor dishwasher or at least in directly adjacent sides of the housing of the conveyor dishwasher.

This configuration makes it possible to realize a particularly compact construction of the conveyor dishwasher along with a reduced set-up area, which extends the application area of the conveyor dishwasher. Its compactness means that the conveyor dishwasher has a relatively low weight and, while maintaining the same high level of convenience and good cleaning results, requires only a small amount of space.

In particular it is possible, on account of its small outer dimensions and of the relatively small amount of space which it therefore requires, for the conveyor dishwasher also to be placed on kitchen work tops or even to be integrated as a built-in unit in a kitchen. It is also suitable, in particular, for use in relatively small spaces, e.g. in break rooms or in kitchens used by relatively small companies.

According to one aspect of the present invention, the conveyor dishwasher serves to clean reusable drinking vessels, for example coffee cups, and is designed to be set up directly on a drinks machine, in particular hot-drinks machine, or in the immediate vicinity of a drinks machine, in particular hot-drinks machine.

Currently, drinks machines, in particular hot-drinks machines, are usually provided with a device for discharging disposable containers which, once used, end up as waste and/or, once legal provisions come into force, are subject to take-back duty.

There are also drinks machines which do not provide, or discharge, any containers and for which the user uses his own cup or the like, which he cleans himself after use. An unnecessarily large amount of fresh water is thus used up if the user does not make an effort to be economical. Accordingly, there is also an unnecessarily large amount of wastewater and, moreover, paper towels or the like are required for drying the user's reusable container, and these paper towels, in turn, end up as waste.

The compact construction of the conveyor dishwasher according to the invention means that the latter is also suitable, in particular, as a dishwasher for reusable drinking vessels, for example a coffee-cup dishwasher, which can be set up in the immediate surroundings of the hot-drinks machine/coffee machine or is even partially integrated in the hot-drinks machine.

The conveyor dishwasher has a feed-in region, into which the dirty washware (in particular drinking vessel) is introduced. Furthermore, the conveyor dishwasher has a discharging region, which is spatially separate from the feed-in region and where the clean washware can be removed.

The washware (drinking vessels such as cups, glasses, etc.) can be supplied, and likewise removed, individually (i.e. one after the other); however, it is also basically possible to load the washware in relatively small groups.

The feed-in region and the discharging region, which are spatially separate from one another, are preferably located on the same side of the machine, i.e. in one and the same side of the housing of the conveyor dishwasher. It is thus conceivable, for example, for the feed-in region and the discharging region, at least in part, to be arranged one above the other and possibly offset laterally in relation to one another. This arrangement makes it possible for the washware which is to be cleaned to be transported through the at least one treatment zone of the conveyor dishwasher along a three-dimensionally curved route, as result of which a particularly compact construction of the conveyor dishwasher can be realized.

In particular, embodiments of the conveyor dishwasher make provision for the at least one treatment zone to have at least one wash zone and at least one final rinse zone, which is separate from the wash zone, wherein the wash zone and the final rinse zone, within the housing of the conveyor dishwasher, are arranged, at least in part, one above the other, i.e. are spaced apart vertically from one another, and are possibly offset laterally (i.e. horizontally) in relation to one another. In particular, it is recommended here for the final rinse zone to be arranged above the wash zone such that final rinse liquid sprayed in the final rinse zone flows under gravitational force to the wash zone and is used there (again) as wash liquid.

The invention is not restricted to embodiments in which the final rinse zone and the wash zone are spaced apart vertically from one another. Also conceivable are embodiments in which the final rinse zone and the wash zone are arranged in the same horizontal plane. In particular in the case of such embodiments, a splash guard, in particular in the form of a curtain, should be arranged between the treatment zones in order to prevent the already cleaned washware from becoming dirty again.

The invention also relates to embodiments in which the at least one wash zone and the at least one final rinse zone are realized in one and the same treatment zone. In the case of these embodiments, the washing and final rinsing then take place at points in time one after the other.

In particular, it is conceivable here for the conveyor dishwasher to have a control device which is designed to activate the transporting apparatus such that, by means of the transporting apparatus, the washware which is to be cleaned is transported in a discontinuous manner from the feed-in region of the conveyor dishwasher, through the at least one treatment zone, to the discharging region of the conveyor dishwasher.

If, in contrast, the final rinse zone and the wash zone are not realized in one and the same treatment zone, it is recommended for the conveyor dishwasher to have a control device which is designed to activate the transporting apparatus such that, by means of the transporting apparatus, the washware which is to be cleaned is transported in a continuous manner, and in particular at a previously defined or definable transporting speed, through the at least one treatment zone.

As already indicated, preferred embodiments make provision for the feed-in region and the discharging region to be arranged one above the other. For this purpose, it is necessary for the washware to be transported along a three-dimensionally curved route in the housing of the conveyor dishwasher. Embodiments therefore provide for the transporting apparatus to have a spiral or a helix conveyor and/or a carousel conveyor.

For example, the transporting apparatus can have at least one endless conveyor belt which has links connected to one another in an articulated manner.

As an alternative, or in addition, it is conceivable for the transporting apparatus to have a helix conveyor with at least one conveying screw. For example, the helix conveyor can have two, and preferably three, parallel conveying screws, which can be rotated relative to the housing of the conveyor dishwasher and between which the washware can be stacked. It is for example conceivable here for the peripheral region of the washware items to be accommodated by turns of an internal thread.

As an alternative, or in addition, it is also possible for the transporting apparatus to have a carousel conveyor, for example a turntable, in order to allow the washware to be conveyed in a circular manner.

For transfer to the transporting apparatus, alignment of the washware and also orientation of the washware can be necessary. It is possible for correct alignment and/or orientation to be achieved mechanically in the conveyor dishwasher or, more straight forwardly, to be ensured by the user during loading, i.e. when feeding the washware into the feed-in region. This can be aided by the necessary orientation being indicated for example visually.

According to a preferred embodiment of the present invention, for this purpose, the feed-in region has an access opening with a guideway which corresponds to the drinking vessel which is to be cleaned, wherein the guideway predetermines an orientation and possibly alignment of the washware (drinking vessel) during introduction of the washware (drinking vessels) into the feed-in region of the conveyor dishwasher.

According to embodiments of the conveyor dishwasher according to the invention, the discharging region of the conveyor dishwasher is designed in the form of a storage region in which a previously defined or definable number of cleaned drinking vessels can be stored on an interim basis. As an alternative, or in addition, it is conceivable for the feed-in region to be designed in the form of a storage region for the interim storage of drinking vessels which are yet to be cleaned.

Provision is particularly preferably made for the conveyor dishwasher to have a storage region in which a previously defined or definable number of cleaned drinking vessels can be stored on an interim basis, wherein the transporting apparatus is designed to transport drinking vessels as required from the storage region to the discharging region of the conveyor dishwasher. This solution has the advantage that, in the discharging region, a drinking vessel is discharged only when required by the user. This therefore rules out already cleaned washware in the discharging region from becoming dirty.

The storage region can be a plate onto which the transporting apparatus pushes the cleaned drinking vessels (e.g. cups, mugs and the like) one after the other. For this purpose, the transporting apparatus can have, for example, a conveyor belt.

If the conveyor dishwasher is used in combination with a hot-drinks machine, it is advantageous if the drinking vessel is pre-heated in the storage region or at least in the discharging region of the conveyor dishwasher. It is conceivable here, for example, to provide a corresponding heating device in the storage region or in the discharging region. The heating device can be in the form of heating coils beneath, or of radiant heaters above, the storage region and/or discharging region.

Moreover, the heating device can be arranged such that the drinking vessels are already being heated as they move out of the final rinse zone to the discharging region or storage region. In the case of a particularly advantageous embodiment of the invention, the heating device can also be used for drying the drinking vessels.

According to a further aspect of the present invention, provision is made for the conveyor dishwasher to be designed in the form of a reverse vending machine for reusable drinking vessels, in particular coffee cups, and preferably to have a money-return device. The money can be returned in the form of cash, a voucher, a chip card or by means of a cashless credit system, etc.

According to a development of the conveyor dishwasher according to the invention, the latter has a control device in order to activate the transporting apparatus and the activatable components (pump, valve, heating device, etc.) assigned to the wash zone and final rinse zone. The control device is preferably designed to coordinate the transportation of the washware through the treatment zones in dependence on the presence or absence of drinking vessels in the feed-in region and/or discharging region.

The invention also relates to an arrangement having a drinks machine and a conveyor dishwasher of the aforementioned type according to the invention. The drinks machine is, for example, a dispenser for hot drinks (hot-drinks machine). Of course, the drinks machine can also be designed in the form of a cold-drinks machine. Combined forms are also conceivable and are covered here.

The combination of a drinks machine and conveyor dishwasher has the advantage that it is no longer necessary for the drinks machine—as is customary—to have a dispensing shaft for disposable drinks containers stored there. It is therefore also possible for the drinks machine to be more compact and, at the same time, at least less waste, if any at all, is produced during operation of the drinks machine.

The conveyor dishwasher according to the invention can be designed, in particular, in the form of an add-on unit for drinks machines. Such an add-on unit should be understood to mean a separate, modular functional unit in relation to the drinks machine.

As an alternative, however, it is also conceivable for the conveyor dishwasher according to the invention and the drinks machine to be combined in the form of an overall system.

In particular in the case of a combined, overall system, the final rinse zone or wash zone of the conveyor dishwasher and the drinks machines can be assigned a common water heater. The invention here is based on the knowledge that both drinks machines and dishwashers use hot water.

Various advantages can be achieved by the drinks-making device of the drinks machine and the conveyor dishwasher having a common hot-water generator. A common heating device for generating hot water is advantageous not just from the point of view of energy, but also on account of the lower level of technical outlay required. It also saves space, as a result of which the combination of the conveyor dishwasher and drinks machine can be rendered further compact. The heating device used is usually in the form of a flow heater or boiler systems, which are preferably integrated in the drinks-making device of the drinks machine.

It is also advantageous, in respect of simplifying the system and in respect of rendering the system as user-friendly as possible, if the drinks machine and the conveyor dishwasher are assigned a common fresh-water connection and/or a common connection for electrical energy.

### BRIEF DESCRIPTION OF THE DRAWINGS

The invention will be described in more detail hereinbelow with reference to the accompanying drawings, in which:

FIG. 1 shows, schematically, an isometric view of an exemplary embodiment of the conveyor dishwasher according to the invention; and

FIG. 2 shows, schematically, an isometric view of an arrangement comprising the exemplary embodiment of the dishwasher according to the invention from FIG. 1 and a hot-drinks machine.

### DETAILED DESCRIPTION

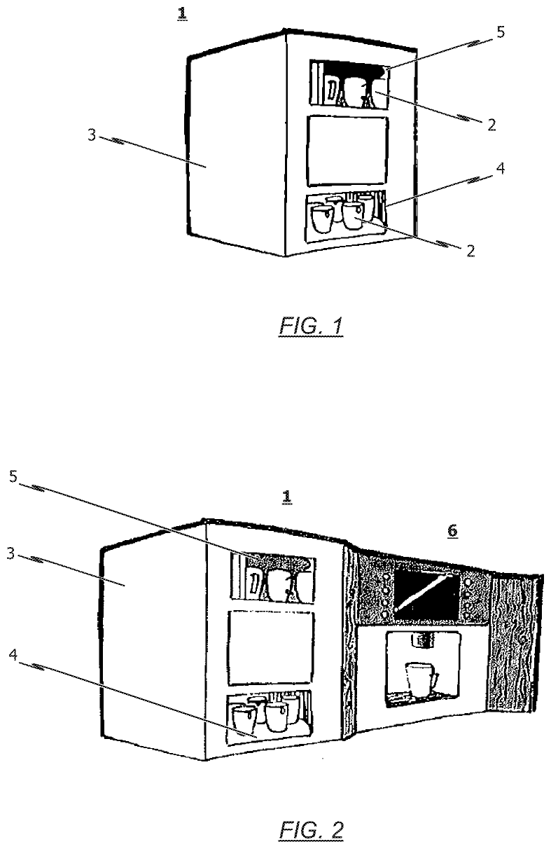

FIG. 1 shows, schematically, an isometric view of an exemplary embodiment of the conveyor dishwasher 1 according to the invention. The conveyor dishwasher 1 has a housing 3, in which a wash zone and also a final rinse zone are accommodated.

The final rinse zone is a fresh-water final rinse zone, in which fresh water with final rinse agent possibly added is sprayed onto the washware 2 which is to be treated.

It is conceivable here for yet another treatment zone, in the form of a pump-assisted final rinse zone, to be provided between the wash zone and the final rinse zone. In this pump-assisted final rinse zone, the liquid sprayed previously in the fresh-water final rinse zone is sprayed onto the washware 2 with recirculating action.

The individual treatment zones of the conveyor dishwasher 1 are spatially separated from one another, wherein a corresponding splash guard, for example in the form of a curtain, can be provided between the treatment zones in order to prevent excess splashing of liquid and to prevent the washware from becoming dirty again.

The exemplary embodiment of the conveyor dishwasher 1 according to the invention, as is illustrated by way of example in FIG. 1, is distinguished in that it has a feed-in region 4, into which the washware 2 which is to be cleaned in the conveyor dishwasher 1 can be fed in/inserted manually. Also provided is a discharging region 5, which is separate from the feed-in region and via which the washware 2 treated/cleaned in the treatment zones of the conveyor dishwasher 1 is discharged.

The feed-in region 4 and the discharging region 5 are formed, in particular, in one and the same side of the housing 3 of the conveyor dishwasher 1. Specifically, the exemplary embodiment shown in FIG. 1 makes provision for the discharging region 5 to be above the feed-in region 4.

The conveyor dishwasher 1 also has a transporting apparatus (not shown in the drawings), by means of which the (dirty) washware 2 fed into the feed-in region 4 is conveyed through the treatment zones of the conveyor dishwasher 1 to the discharging region 5. The transporting apparatus is designed here such that the washware 2 can be conveyed along a curved three-dimensional route. This design allows the entire volume of the housing 3 of the conveyor dishwasher 1 to be utilized effectively, as result of which a particularly compact construction of the conveyor dishwasher 1 can be realized.

In order for the washware 2 to be transported through the treatment zones of the conveyor dishwasher 1, the transporting apparatus has, for example, a helix conveyor or a spiral conveyor.

It is also conceivable here in principle, however, for the treatment zones (wash zone and final rinse zone) of the conveyor dishwasher 1, rather than being arranged one above the other, to be arranged one beside the other, i.e. in one and the same plane. In the case of this embodiment, the transporting apparatus has, for example, a carousel conveyor or turntable conveyor, in order thus also to ensure that the washware 2 is transported in the X and Y directions.

The compactness of the conveyor dishwasher 1 means that the loading opening of the feed-in region 4 can be correspondingly small. If—as is the case with the exemplary embodiment shown in the drawings—the conveyor dishwasher 1 serves to clean drinking vessels, in particular reusable drinking vessels such as coffee cups, the loading opening of the feed-in region 4 can be a little higher than the drinking vessel which is to be treated.

Although not illustrated in FIG. 1, the access opening of the feed-in region 4 of the conveyor dishwasher 1 can be assigned a guideway which corresponds to the drinking vessel which is to be cleaned, in order to predetermine an orientation of the drinking vessel when the drinking vessel is introduced into the feed-in region 4.

The discharging region 5 of the conveyor dishwasher 1 according to FIG. 1 is designed in the form of a storage region and serves for the interim storage of a previously defined or definable number of cleaned drinking vessels. In the same way, the feed-in region 4 of the conveyor dishwasher 1 can likewise be designed in the form of a storage region, for the interim storage of a previously defined or definable number of drinking vessels which are to be cleaned. This allows so-called batch operation of the conveyor dishwasher 1.

The conveyor dishwasher 1 preferably has a control device for correspondingly activating the transporting apparatus and the activatable components assigned to the wash zone and final rinse zone. The control device is designed so that the transporting apparatus of the conveyor dishwasher 1 and possibly the activatable components of the wash zone and final rinse zone are activated in dependence on a presence or absence, or in dependence on a number, of drinking vessels in the feed-in region 4 and/or discharging region 5.

FIG. 2 shows an arrangement of the conveyor dishwasher 1 from FIG. 1 on a hot-drinks machine 6. The conveyor dishwasher 1 and the hot-drinks machine 6 can be combined in the form of an overall system. As an alternative, however, it is also conceivable for the conveyor dishwasher 1 to be designed in the form of a separate, modular functional unit in relation to the hot-drinks machine 6.

The conveyor dishwasher 1 and the hot-drinks machine 6 are advantageously assigned a common water heater. The same applies to the water connection and the connection for electrical energy.

Although not illustrated in the drawings, it is conceivable for the conveyor dishwasher 1 to be designed in the form of a reverse vending machine for reusable drinking vessels, in particular coffee cups, and preferably to have a corresponding money-return device.

If used in combination with a drinks machine, in particular hot-drinks machine 6, the conveyor dishwasher 1 according to the invention can use reusable crockery and therefore avoids waste, etc.

Although not illustrated in the drawings, preferred realizations of the solution according to the invention make provision for the dirty drinks containers to be conveyed into the lower feed-in region 4 with their opening facing downward and to be conveyed upward via a rotary helix mechanism. The containers here undergo washing, rinsing and, optionally, drying steps until they reach an upper endpoint, where the clean-side discharging region 5 is located.

A further conceivable solution is a straightforward carousel solution, in which the feed-in region 4 and the discharging region 5, although located on one side, are not at different heights.

The solution according to the invention can save time in respect of handling. Dirty washware 2 (drinking vessels) passes directly into the conveyor dishwasher 1, i.e. there is no need for dirty drinking vessels to be transported into a kitchen and for cleaning drinking vessels to be transported back from the kitchen to the hot-drinks machine 6.

Furthermore, the invention saves space, since there is no need for any space around the hot-drinks machine 6 for the purpose of storing clean and dirty drinking vessels.

Finally, the area around the hot-drinks machine 6 can be kept in better order, since there is no need to provide any storage for dirty drinking vessels. The only space for cups or drinking vessels is in the conveyor dishwasher 1 and/or in the corresponding discharging region 5 or storage region.

The above-described conveyor dishwasher facilitates a method in which washware is fed into a feed-in region on one side of the conveyor dishwasher housing, transported from the feed-in region through at least one treatment zone within the housing, such as through a wash zone and a final rinse zone, and the washware is then fed out at a discharging region that is on the same side of the housing as the feed-in region. In one implementation the feed-in region is below the discharge region, and at least one treatment zone is spaced vertically between the two regions.

Rather than being restricted to those exemplary embodiments which are shown in the drawings, the invention is a combination of all the features disclosed therein.

### LIST OF REFERENCE SIGNS

1 Conveyor dishwasher
2 Washware/drinking vessels
3 Housing
4 Feed-in region
5 Discharging region
6 Drinks machine

1. A conveyor dishwasher for cleaning washware, in the form of drinking vessels, wherein the conveyor dishwasher has at least one treatment zone and also a housing, in which the at least one treatment zone is accommodated, wherein the conveyor dishwasher also has a dirty-side feed-in region, by way of which washware which is to be cleaned in the at least one treatment zone of the conveyor dishwasher is fed in manually, and a clean-side discharging region, by way of which washware cleaned in the at least one treatment zone of the conveyor dishwasher is discharged and removed manually, wherein the conveyor dishwasher also has a transporting apparatus for transporting washware from the dirty-side feed-in region, through the at least one treatment zone, to the clean-side discharging region,
wherein
the dirty-side feed-in region and the clean-side discharging region are formed in one and the same side of the housing of the conveyor dishwasher or in directly adjacent sides of the housing of the conveyor dishwasher.

2. The conveyor dishwasher as claimed in claim 1,
wherein the dirty-side feed-in region and the clean-side discharging region, at least in part, are arranged one above the other and are possibly offset laterally in relation to one another.

3. The conveyor dishwasher as claimed in claim 1,
wherein the at least one treatment zone has at least one wash zone and at least one final rinse zone, and wherein the wash zone and the final rinse zone, at least in part, are arranged one above the other and are possibly offset laterally in relation to one another; and/or
wherein the at least one treatment zone has at least one wash zone and at least one final rinse zone, and wherein the final rinse zone is arranged, at least in part, above the wash zone such that final rinse liquid sprayed in the final rinse zone flows under gravitational force to the wash zone and is used there as wash liquid.

4. The conveyor dishwasher as claimed in claim 1,
wherein the at least one treatment zone has at least one wash zone and at least one final rinse zone, and wherein the final rinse zone and the wash zone are arranged in the same horizontal plane and are separated from one another via a splash guard, in the form of a curtain.

5. The conveyor dishwasher as claimed in claim 1,
wherein the conveyor dishwasher has a control device which is designed to activate the transporting apparatus such that, by means of the transporting apparatus, the washware which is to be cleaned is transported in a
discontinuous manner from the dirty-side feed-in region of the conveyor dishwasher, through the at least one treatment zone, to the clean-side discharging region of the conveyor dishwasher; or
wherein the conveyor dishwasher has a control device which is designed to activate the transporting apparatus such that, by means of the transporting apparatus, the washware which is to be cleaned is transported in a continuous manner, at a previously defined or definable transporting speed, through the at least one treatment zone.

6. The conveyor dishwasher as claimed in claim 1,
wherein the transporting apparatus has a spiral or a helix conveyor and/or a carousel conveyor.

7. The conveyor dishwasher as claimed in claim 1,
wherein the dirty-side feed-in region has an access opening with a guideway which corresponds to the drinking vessel which is to be cleaned and is intended for predetermining an orientation of the drinking vessel when the drinking vessel is introduced manually into the dirty-side feed-in region.

8. The conveyor dishwasher as claimed in claim 1,
wherein the clean-side discharging region is designed in the form of a storage region for the interim storage of a previously defined or definable number of cleaned drinking vessels; and/or
wherein the dirty-side feed-in region is designed in the form of a storage region for the interim storage of a previously defined or definable number of drinking vessels which are to be cleaned.

9. The conveyor dishwasher as claimed in claim 1,
wherein the conveyor dishwasher has a storage region for the interim storage of a previously defined or definable number of cleaned drinking vessels, and wherein the transporting apparatus is designed so that drinking vessels which are stored on an interim basis as required in the storage region are transported to the clean-side discharging region of the conveyor dishwasher.

10. The conveyor dishwasher as claimed in claim 1,
wherein the conveyor dishwasher is designed in the form of a reverse vending machine for reusable drinking vessels, has a money-return device.

11. The conveyor dishwasher as claimed in claim 1,
wherein the conveyor dishwasher has a control device for activating the transporting apparatus and/or for activating activatable components assigned to the at least one treatment zone, wherein the control device is designed so that the transporting apparatus and possibly the activatable components assigned to the at least one treatment zone are activated in dependence on a presence or absence, or in dependence on a number, of drinking vessels in the dirty-side feed-in region and/or clean-side discharging region.

12. An arrangement having a drinks machine, and a conveyor dishwasher as claimed in claim 1.

13. The arrangement as claimed in claim 12,
wherein the final rinse zone of the conveyor dishwasher and the drinks machine are assigned a common water heater.

14. The arrangement as claimed in claim 12,
wherein the drinks machine and the conveyor dishwasher are assigned a common fresh-water connection and/or a common connection for electrical energy.

15. The arrangement as claimed in claim 12,
wherein the conveyor dishwasher and the drinks machine are combined in the form of an overall system; or
wherein the conveyor dishwasher is designed in the form of a separate, modular functional unit in relation to the drinks machine.
